(19) United States
(12) Patent Application Publication
(10) Pub. No.: US 2020/0219427 A1
(43) Pub. Date: Jul. 9, 2020

(54) FLAG POLE ASSEMBLY

(71) Applicant: B&C Solutions LLC, GLADWIN, MI (US)

(72) Inventors: Sawyer C. DeShano, Gladwin, MI (US); Caleb B. Wright, Swartz Creek, MI (US); Boone G. DeShano, Gladwin, MI (US)

(73) Assignee: B&C Solutions LLC, GLADWIN, MI (US)

(21) Appl. No.: 16/243,313

(22) Filed: Jan. 9, 2019

(51) Int. Cl. G09F 17/00

(52) U.S. Cl. CPC G09F 17/00; G09F 2017/0041; G09F 2017/0025

(57) ABSTRACT

A flag pole assembly is disclosed for supporting flags and banners. The flag pole assembly includes an elongated male member having a first and second elongated perpendicular banner member and a sleeve for receiving a flag pole, a female member formed of a C-shaped elongated member for receiving the elongated member. The elongated member can include a first and second rod-shaped members at a first and a second endmost position of the elongated member for ease of installation and securement within the female member.

### TECHNICAL FIELD

This invention relates to flags, and more particularly to attaching a flag or banner to flag poles, posts, and other vertical structures.

### BACKGROUND

The statements in this section merely provide background information related to the present disclosure and may not constitute prior art.

Utility and ornamental poles are well known in the art and often decorated in cities and towns with various seasonal flags, signs or banners that are changed throughout the year. Unfortunately, such poles typically do not provide means for raising, lowering and easily removing and changing the signs, flags, or banners. Often, the task of changing or removing requires the use of a ladder, crane, or other personnel lifting device, which is inconvenient, slow, costly and conducive to injury.

Therefore, a need exists for an assembly to improve ease of installation of signs, flags, or banners in a safe manner.

### SUMMARY

A flag pole assembly is disclosed for supporting flags and banners. The flag pole assembly includes an elongated male member having a first and second elongated perpendicular banner member and a sleeve for receiving a flag pole, a female member formed of a C-shaped elongated member for receiving the elongated member. The elongated member can include a first and second rod-shaped members at a first and a second endmost position of the elongated member for ease of installation and securement within the female member.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1 is a perspective view of an exemplary flag pole assembly installed on an exemplary pole, in accordance with the present disclosure;

FIG. 2 is a side view of a male member of the flag pole assembly, in accordance with the present disclosure;

FIG. 3 is a front view of the male member of the flag pole assembly, in accordance with the present disclosure;

FIG. 4 is a rear view of the male member of the flag pole assembly, in accordance with the present disclosure;

FIG. 5 is a side view of a female member of the flag pole assembly, in accordance with the present disclosure;

FIG. 6 is a front view of a female member of the flag pole assembly, in accordance with the present disclosure;

FIG. 7 is a cross-sectional view along line B-B of FIG. 6, in accordance with the present disclosure;

FIG. 8 is a cross-sectional view along line A-A of FIG. 4, in accordance with the present disclosure;

FIG. 9 is an enlarged view showing an exemplary banner member attachment, in accordance with the present disclosure;

FIG. 10 is an enlarged perspective view showing an exemplary handle on the male member, in accordance with the present disclosure;

FIG. 11 is an enlarged perspective view showing an exemplary flag mount member, in accordance with the present disclosure;

FIGS. 12A-12D illustrate an exemplary installation technique of the flag pole assembly, in accordance with the present disclosure; and

FIG. 13 shows a spacer members, in accordance with the present disclosure.

### DETAILED DESCRIPTION

Reference throughout this specification to “one embodiment,” “an embodiment,” or similar language means that a particular feature, structure, or characteristic described in connection with the embodiment is included in at least one embodiment of the subject matter of the present disclosure. Appearances of the phrases “in one embodiment,” “in an embodiment,” and similar language throughout this specification may, but do not necessarily, all refer to the same embodiment.

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” The term “based upon” is not exclusive and allows for being based on additional factors not described, unless the context clearly dictates otherwise. Additionally, in the subject description, the word “exemplary” is used to mean serving as an example, instance or illustration. Any embodiment or design described herein as “exemplary” is not necessarily to be construed as preferred or advantageous over other embodiments or designs. Rather, use of the word exemplary is intended to present concepts in a concrete manner.

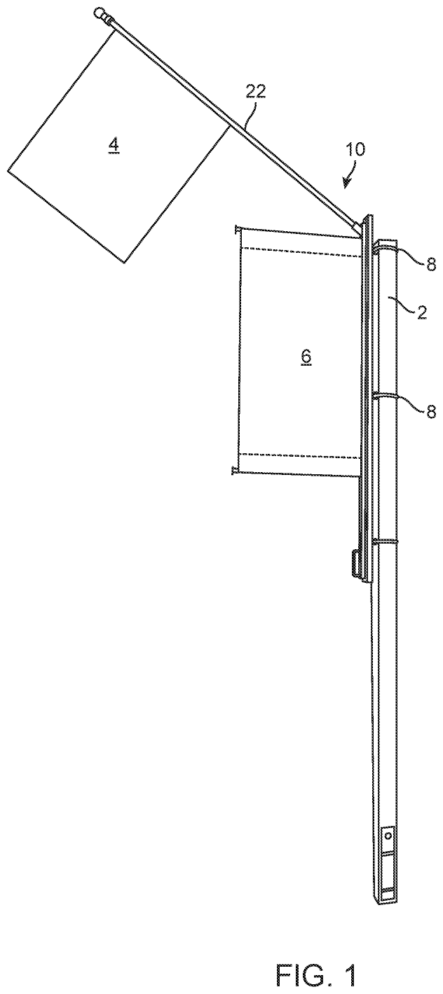

Referring now to the drawings, wherein the depictions are for the purpose of illustrating certain exemplary embodiments only and not for the purpose of limiting the same, FIG. 1 schematically shows an exemplary flag pole assembly 10 installed on an exemplary pole 2. As FIG. 1 shows, the flag pole assembly 10 has received a flag 4 and banner 6 for display vertically along the pole 2. The flag pole assembly 10 may be attached to the pole 2 in most any manner including using straps, clamps, clips, or other mechanical fastener. Ties may be used in some applications such as but not limited to plastic ties, cord pieces, rubber bands, wires, and the like. In one embodiment, a plurality of screw band hose clamps 8 are threaded through an opening 20 and tightened around the pole 2 to secure the assembly 10 to the pole 2. The opening 20 may be defined by a U-shaped member and a surface of a female member 14 adapted to rest against the pole 2, when installed.

The flag pole assembly 10 is formed of a male member 12 and a female member 14.

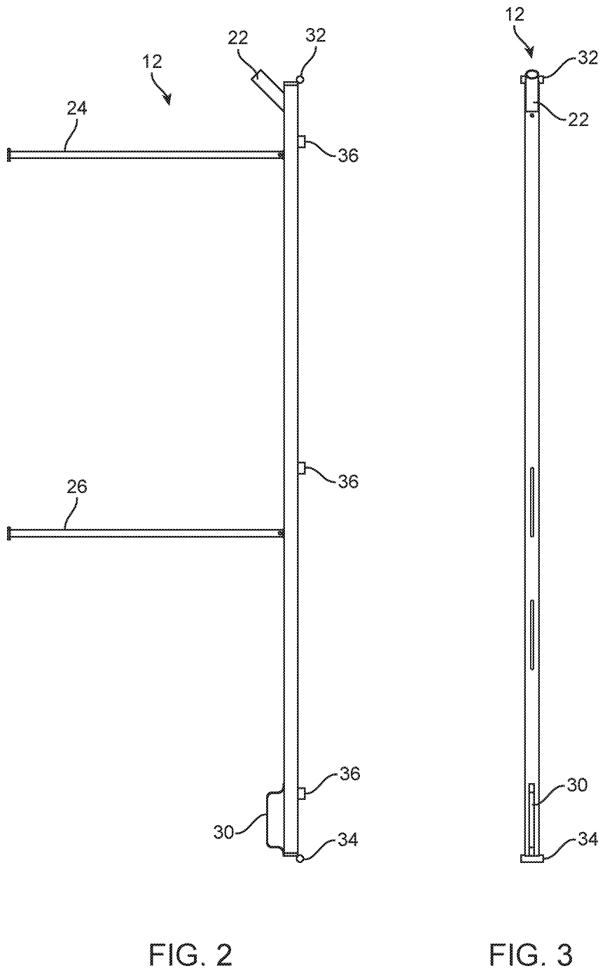

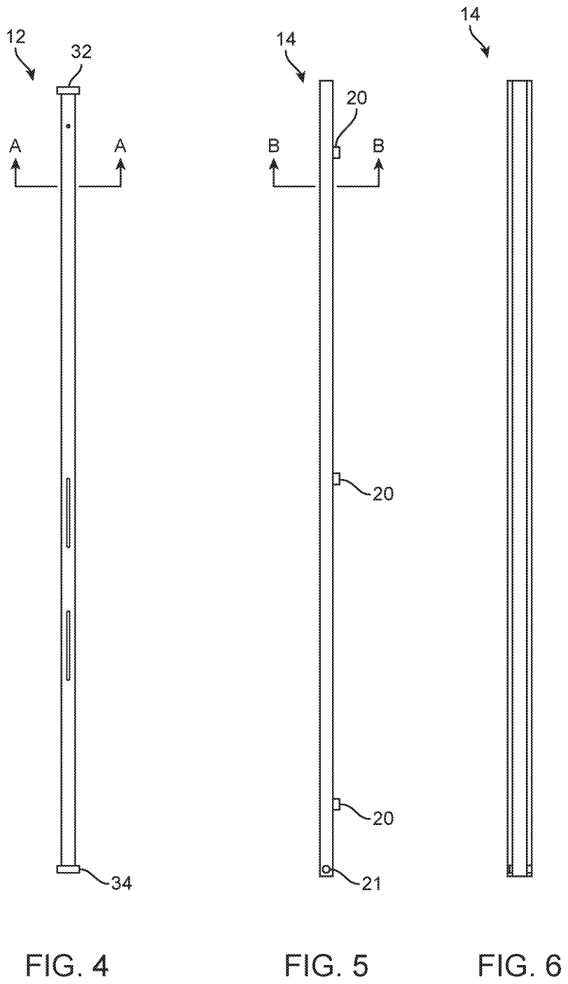

FIGS. 2-4 show the male member 12 of the assembly 10, while FIGS. 5 and 6 show the female member 14 of the assembly 10. As FIGS. 2-4 show, the male member 12 includes a flag mount member 22 configured to receive a pole, or elongated member, of a flag 4. In one embodiment, the flag mount member 22 is a cylindrical-shaped sleeve which may be integral formed of the male member 12 or otherwise secured thereon, such as via a weld. The flag mount member 22 is situated at an angle, relative to the front surface. In one embodiment, the flag mount member 22 is at a 45-degree angle.

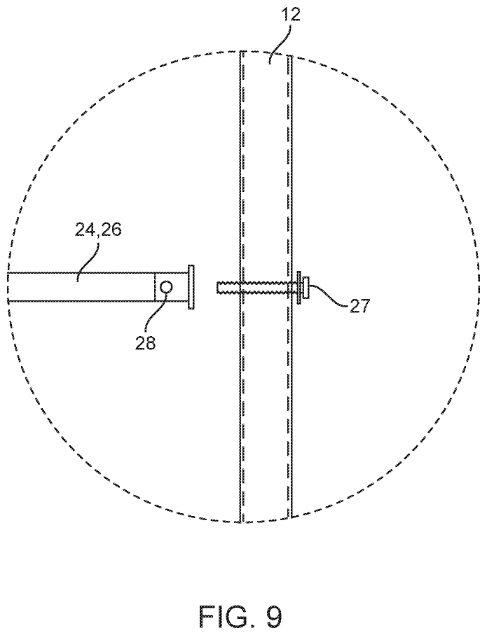

In one embodiment, the male member 12 include a first and a second banner member 24 and 26, respectively. These banner members 24 and 26 are elongated members configured to receive a banner 6, preferably at a perpendicular angle with respect to a front surface of the member 12. In one embodiment, the banner members 24 are cylindrically-shaped. In one embodiment, the banner members 24 and 26 have a circular cross-section. The banner members 24 and 26 may be welded to a surface of the male member 12. As shown in FIG. 9, in one embodiment, the banner members 24 and 26 have a support collar 25. The collar 25 and/or space within the banner members 24 and 26 may be configured to receive a threaded bolt 27 to secure the banner members 24 and 26 to the male member 12. The banner members 24 and 26 may have a hole 28 with which a spot weld may be made to the bolt 27 and/or the banner members 24 and 26 for additional support. In one embodiment, a gusset may be included between the banner members 24 and 26 and the male member 12 to provide additional support.

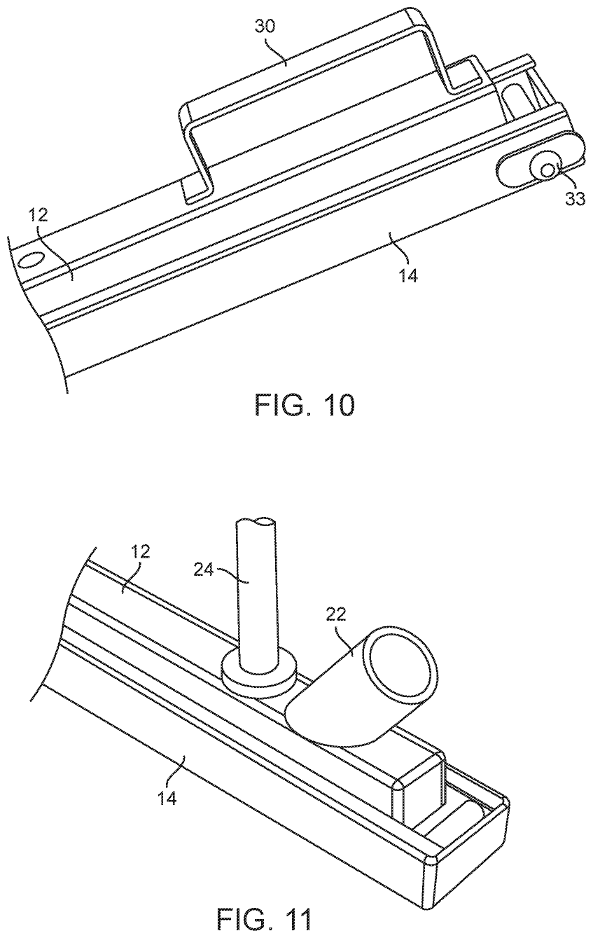

With reference to FIGS. 2 and 10, in various embodiments a handle 30 may be included on the male member 12. As FIGS. 2 and 10 show, the handle 30 may be formed on a lower end of the male member 12. In this way, during installation of the assembly 10, a user may maximize a vertical distance one may extend the member 12 for securing. The handle may be integrally formed of the member 12 or welded to the surface thereon.

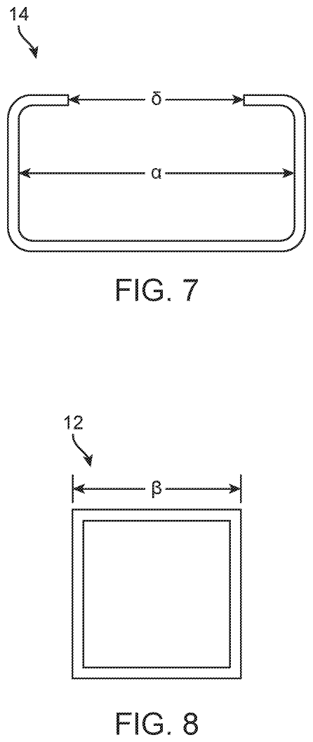

With reference to FIGS. 2, 4, 10, and 11, the male member 12 includes a first and second slider member 32 and 34, respectively. The first and second slider member 32 and 34 are rod-shaped members that extend the width of the male member 12. The first and second slider member 32 and 34 are sized to fit within the female member 14 to reduce friction when raising the male member 12 into place when displaying a flag or banner. The first and second slider member 32 and 34 should have a length less than an interior width of the sidewalls α and a length greater than a distance between the opening δ within the female member 14 as shown in FIG. 7, and a length greater than a width β of the male member 12 as shown in FIG. 8. The width β is less than the width a, so that the male member 12 slides within the female member 14 without undue friction. In one embodiment the β is less than the distance of the female member 14 opening δ.

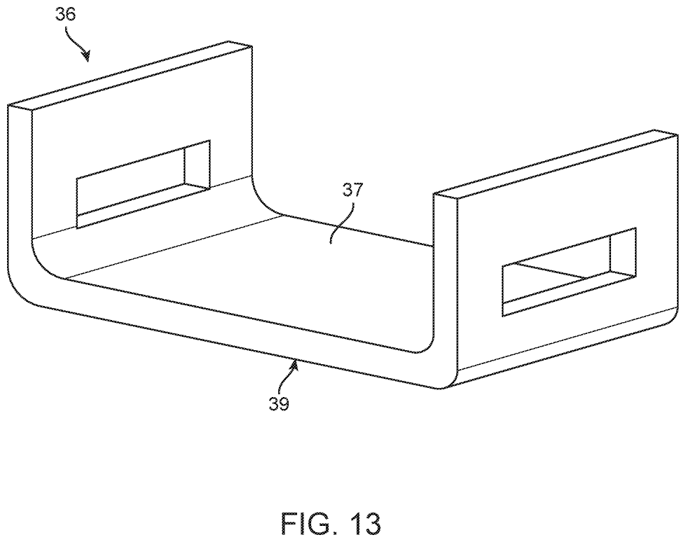

In one embodiment of the male member 12, additional spacer members 36 may be used to provide additional support and guard against undesired movement or flexing of the male member 12. The spacer members 36 provides depth from the female member 14, when assembled. FIG. 13 shows an exemplary spacer member 36. As FIG. 13 shows, the member 36 may be welded or otherwise attached to a rear surface of the male member 12 at a surface 39 so that the inner surface 37 faces outward. In one embodiment, the spacer members 36 have a depth less than a depth of the rod-shaped members 34.

As FIGS. 5, 6, and 7 show, the female member 14 is formed of an elongated C-shaped member. There is an elongated opening, having a width 6 that extends the length of the member 14. In one embodiment the member 14 includes gaps or openings within protrusions 20 to receive the fasteners for securing to a pole 2 or other vertical structure. In one embodiment, the protrusions and openings thereon are simple handle-like structures welded to a rear surface of the member 14. In one embodiment, a hole 21 is included on a lower end to traverse the width of the member 14. When the male member 12 is inserted into the female member 14, a screw or other fastener may be threaded through the hole 21 to site below the handle 30. In this way, the member 12 is prevented from falling out of the member 14 and secured in place.

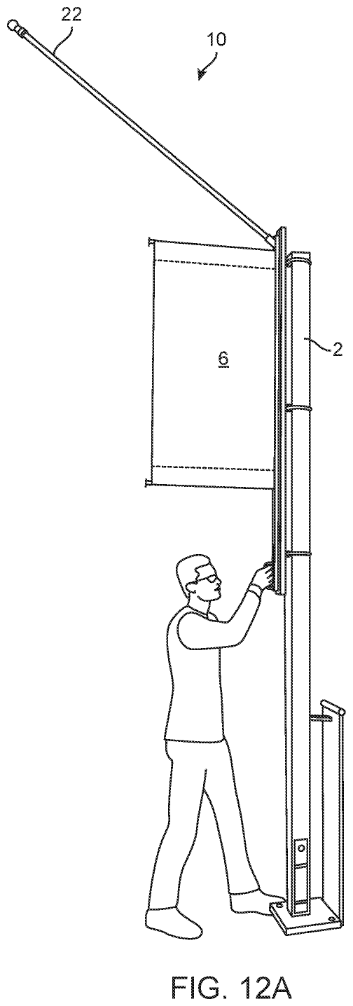

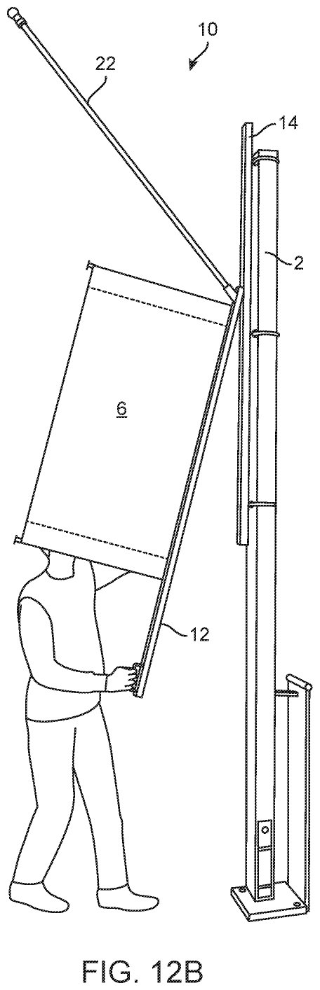

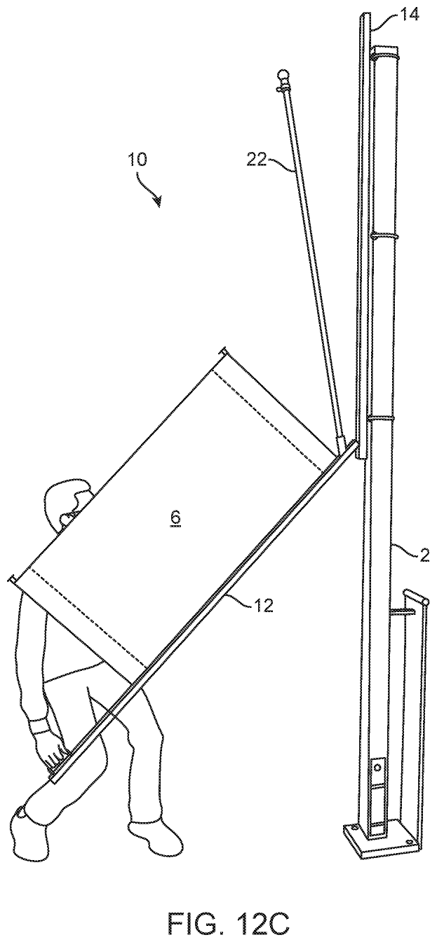

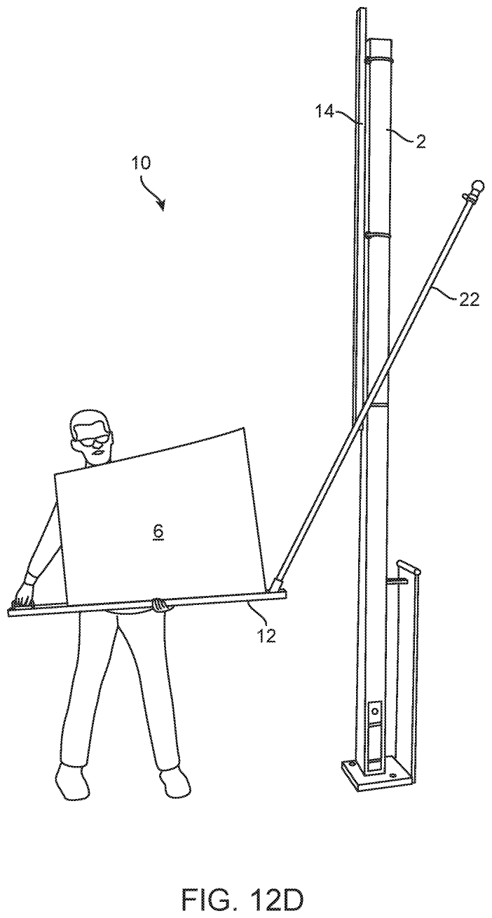

FIGS. 12A-12D illustrate a series of exemplary movements to remove a male member 12 from a female member 14. FIG. 12A shows a user gripping the handle 30 after removing a screw or other fastener 33 through the hole 21. FIG. 12B shows the member 12 pivoting out of the member 14. At the top end the first slider 32 prevents the top of the member 12 from moving side-to-side or out of the member 14 without first traversing the entire length of the member 14. FIG. 12C shows the member 12 just before the member 12 may be removed from the member 14. FIG. 12D shows removal of the member 12 from the member 14. The steps may be reversed to install the member 12 within the member 14. Once removed, the user may install or otherwise handle the banner 6 or flag as desired.

As used herein, the phrase “at least one of”, when used with a list of items, means different combinations of one or more of the listed items may be used and only one of the items in the list may be needed. The item may be a particular object, thing, or category. In other words, “at least one of means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.”

While the foregoing disclosure discusses illustrative embodiments, it should be noted that various changes and modifications could be made herein without departing from the scope of the described embodiments as defined by the appended claims. Accordingly, the described embodiments are intended to embrace all such alterations, modifications and variations that fall within scope of the appended claims. Furthermore, although elements of the described embodiments may be described or claimed in the singular, the plural is contemplated unless limitation to the singular is explicitly stated. Additionally, all or a portion of any embodiment may be utilized with all or a portion of any other embodiments, unless stated otherwise.

1. A flag pole assembly for supporting flags and banners, the assembly comprising:
an elongated member having a first and second elongated perpendicular member and a sleeve;
a female member formed of a C-shaped elongated member for receiving the elongated member.

2. The flag pole assembly of claim 1, wherein the elongated member includes a first and a second rod-shaped members at a first and a second endmost position of the elongated member.

3. The flag pole assembly of claim 2, wherein the rod-shaped members have a width greater than a width of the elongated member.

4. The flag pole assembly of claim 2, wherein the rod-shaped members have a width less than an interior width of the female member.

5. The flag pole assembly of claim 4, wherein the rod-shaped members have a width greater than a width of an elongated opening of the female member.

6. The flag pole assembly of claim 1, wherein the rod-shaped members have a width greater than a width of the elongated member and the rod-shaped members have a width less than an interior width of the female member.

7. The flag pole assembly of claim 1, wherein the sleeve is configured to receive a flag pole and the first and second elongated perpendicular members are configured to secure a banner.

8. The flag pole assembly of claim 1, wherein the elongated member includes a handle.

9. The flag pole assembly of claim 2, wherein the elongated member includes a plurality of support protrusions having a depth less than a depth of the rod-shaped members.

10. A flag pole assembly for supporting flags and banners, the assembly comprising:
an elongated member having a first and second elongated perpendicular member and a cylindrical-shaped sleeve, angled off a surface thereof, wherein the elongated member includes a first rod-shaped member at a first endmost position and a second rod-shaped member opposite the first rod-shaped member at a second endmost position on the elongated member;
a female member formed of a C-shaped elongated member for receiving the elongated member.

11. The flag pole assembly of claim 10, wherein the rod-shaped members have a width greater than a width of the elongated member.

12. The flag pole assembly of claim 11, wherein the rod-shaped members have a width less than an interior width of the female member.

13. The flag pole assembly of claim 12, wherein the rod-shaped members have a width greater than a width of an elongated opening of the female member.

14. The flag pole assembly of claim 10, wherein the rod-shaped members have a width greater than a width of the elongated member and the rod-shaped members have a width less than an interior width of the female member.

15. The flag pole assembly of claim 14, wherein the sleeve is configured to receive a flag pole and the first and second elongated perpendicular members are configured to secure a banner.

16. The flag pole assembly of claim 15, wherein the elongated member includes a handle.

17. The flag pole assembly of claim 10, wherein the elongated member includes a plurality of support protrusions having a depth less than a depth of the rod-shaped members.

18. A flag pole assembly for supporting flags and banners, the assembly comprising:
an elongated member having a first and second elongated perpendicular member and a cylindrical-shaped sleeve, angled off a surface thereof, wherein the elongated member includes a first rod-shaped member at a first endmost position and a second rod-shaped member opposite the first rod-shaped member at a second endmost position on the elongated member, wherein the rod-shaped members have a width greater than a width of the elongated member, a width less than an interior width of the female member, and a width greater than a width of an elongated opening of the female member;
a female member formed of a C-shaped elongated member for receiving the elongated member.

19. The flag pole assembly of claim 18, wherein the elongated member includes a handle.

20. The flag pole assembly of claim 19, wherein the elongated member includes a plurality of support protrusions having a depth less than a depth of the rod-shaped members.
